(19) United States
(12) Patent Application Publication
(10) Pub. No.: US 2024/0340732 A1
(43) Pub. Date: Oct. 10, 2024

(54) CELL RE-SELECTION CONFIGURATION METHOD AND APPARATUS, AND COMMUNICATION DEVICE AND STORAGE MEDIUM

(71) Applicant: Beijing xiaomi Mobile Software Co., Ltd., Beijing (CN)

(72) Inventor: Xuhua TAO, Beijing (CN)

(21) Appl. No.: 18/575,964

(22) PCT Filed: Jul. 5, 2021
(86) PCT No.: PCT/CN2021/104581

§ 371 Date: Jan. 2, 2024

(51) Int. Cl. H04W 36/04; H04W 36/30

(52) U.S. Cl. CPC H04W 36/04; H04W 36/30

(57) ABSTRACT

A cell reselection configuration method is performed by an access network device of a multi-carrier cell, and includes: sending reselection configuration information of the multi-carrier cell, wherein the reselection configuration information at least indicates at least one reselection threshold for a user equipment (UE) to perform cell reselection.

### CROSS-REFERENCE TO RELATED APPLICATION

This application is a U.S. national phase application of International Application No. PCT/CN2021/104581, filed on Jul. 5, 2021, the content of which is hereby incorporated by reference in its entirety.

### TECHNICAL FIELD

The disclosure relates to, but is not limited to a field of wireless communication technologies, and more particularly to a cell reselection configuration method and apparatus, a communication device and a storage medium.

### BACKGROUND

In cellular mobile communication, cell reselection refers to a process that a user equipment (UE) selects a best cell for providing a serving signal by monitoring signal qualities of neighboring cells and a serving cell. When the signal quality of a neighboring cell satisfies a cell reselection criterion, the UE will access the neighboring cell and reside in the neighboring cell. In the related art, one cell includes one carrier, and the UE can monitor the signal quality of the carrier to determine whether to perform cell reselection.

### SUMMARY

According to a first aspect of the embodiments of the present disclosure, a cell reselection configuration method is provided. The method is performed by an access network device of a multi-carrier cell, and the method includes:

sending reselection configuration information of the multi-carrier cell, in which the reselection configuration information at least indicates at least one reselection threshold for a user equipment (UE) to perform cell reselection.

According to a second aspect of an embodiment of the present disclosure, an information transmission method is provided. The method is executed by a UE, and the method includes:

receiving reselection configuration information of a multi-carrier cell, in which the reselection configuration information at least indicates at least one reselection threshold for the UE to perform cell reselection.

According to a third aspect of the embodiments of the present disclosure, a communication device is provided. The communication device includes a processor, and a memory storing a program executable by the processor. The processor is configured to perform the cell reselection configuration method described in the first aspect or the information transmission method described in the second aspect.

According to a fourth aspect of the embodiments of the present disclosure, a storage medium is provided, having an executable program stored thereon. When the executable program is executed by a processor, the processor is caused to perform the cell reselection configuration method described in the first aspect or the information transmission method described in the second aspect.

It should be understood that, both the foregoing general description and the following detailed description are exemplary and explanatory only, and do not limit the embodiments of the disclosure.

### BRIEF DESCRIPTION OF THE DRAWINGS

The accompanying drawings, which are incorporated in and constitute a part of the specification, illustrate embodiments consistent with the present invention and serve to explain principles of the embodiments of the present disclosure together with the specification.

FIG. 1 is a schematic diagram of a wireless communication system according to an embodiment;

FIG. 2 is a schematic diagram of a multi-carrier cell according to an embodiment:

FIG. 3 is a flowchart illustrating a cell reselection configuration method according to an embodiment:

FIG. 4 is a flowchart illustrating an information transmission method according to an embodiment:

FIG. 5 is a block diagram illustrating a cell reselection configuration apparatus according to an embodiment:

FIG. 6 is a block diagram illustrating an information transmission apparatus according to an embodiment; and

FIG. 7 is a block diagram illustrating an apparatus for cell reselection configuration or information transmission according to an embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

The terms used in the disclosure are only for the purpose of describing specific embodiments, and are not intended to limit the disclosure. The singular forms of “a” and “the” used in the disclosure and appended claims are also intended to include plural forms, unless the context clearly indicates other meanings. It should also be understood that the term “and/or” as used herein refers to and includes any or all possible combinations of one or more associated listed items.

It should be understood that although the terms “first”, “second”, and “third” may be used in this disclosure to describe various information, the information should not be limited to these terms. These terms are only used to distinguish the same type of information from each other. For example, without departing from the scope of the disclosure, the first information may also be referred to as the second information, and similarly, the second information may also be referred to as the first information. Depending on the context, the term “if” as used herein can be interpreted as “when”, “while” or “in response to determining”.

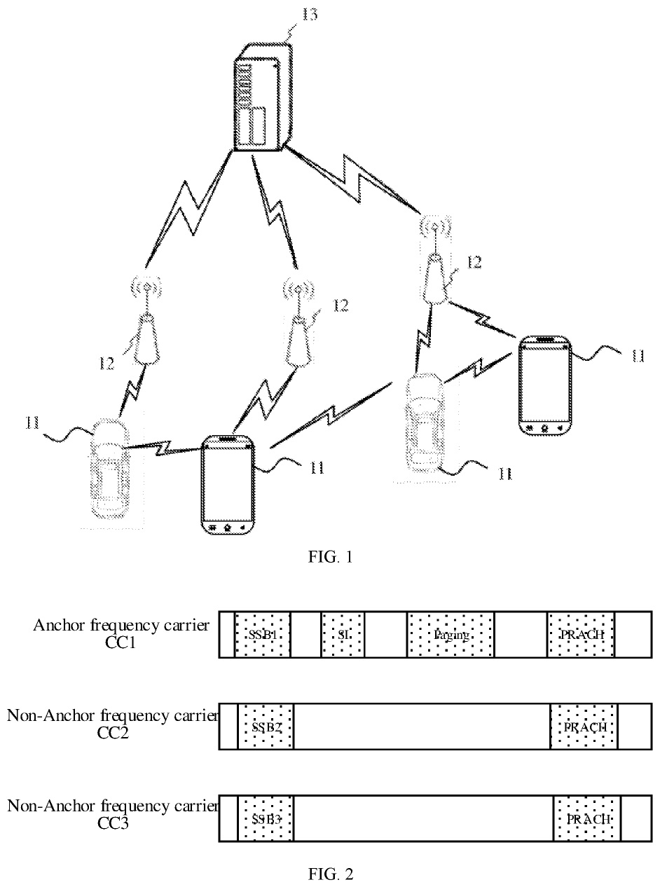

Please refer to FIG. 1, FIG. 1 is a schematic diagram illustrating a wireless communication system according to an embodiment of the disclosure. As illustrated in FIG. 1, the wireless communication system is a communication system based on a cellular mobile communication technology. The wireless communication system may include several terminals 11 and several base stations 12.

The terminal 11 may refer to a device that provides voice and/or data connectivity to a user. The terminal 11 may communicate with one or more core networks via a radio access network (RAN). The terminal 11 may be an internet of things terminal, for example, a sensor device, a mobile phone (or referred to as a “cellular” phone) and a computer having an internet of things terminal, for example, may be a fixed, portable, compact, handheld, computer built-in or vehicle-mounted apparatus, for example, a station (STA), a subscriber unit, a subscriber station, a mobile station, a mobile, a remote station, an access point, a remote terminal, an access terminal, a user terminal, a user agent, a user device or a user equipment (UE). Alternatively, the terminal 11 may be a device of an unmanned aerial vehicle. Alternatively, the terminal 11 may be a vehicle-mounted apparatus, for example, may be an electronic control unit with a wireless communication function, or a wireless user device externally connected to the electronic control unit. Alternatively, the terminal 11 may be a roadside device, for example, may be a street lamp with the wireless communication function, a signal light or other roadside devices, and the like.

The base station 12 may be a network side device in the wireless communication system. The wireless communication system may be a 4th generation mobile communication (4G) system, also referred to as a long term evolution (LTE) system; or the wireless communication system may be a 5G system, also referred to as a new radio (NR) system or a 5G NR system. Alternatively, the wireless communication system may be a next generation system of the 5G system. An access network in a 5G system may be referred to as a new generation-radio access network (NG-RAN), or an MTC system.

The base station 12 may be an eNB adopted in the 4G system. Alternatively, the base station 12 may be a base station (gNB) with a centralized distributed architecture in the 5G system. When the base station 12 adopts the centralized distributed architecture, the base station 12 generally includes a central unit (CU) and at least two distributed units (DU). Protocol stacks of a packet data convergence protocol (PDCP) layer, a radio link control (RLC) layer and a media access control (MAC) layer are configured in the CU; a physical (PHY) layer protocol stack is configured in the DU. The specific implementation of the base station 12 is not limited in the embodiments of the disclosure.

A wireless connection may be established between the base station 12 and the terminal 11 via a wireless air interface. In different implementations, the wireless air interface is a wireless air interface based on a 4G standard: or, the wireless air interface is a wireless air interface based on a 5G standard. For example, the wireless air interface is a new radio interface; or, the wireless air interface may be a wireless air interface based on a standard of next generation mobile communication network technology of the 5G.

In some embodiments, an end to end (E2E) connection can also be established between the terminals 11, for example, in vehicle to vehicle (V2V) communication, vehicle to infrastructure (V2I) communication, vehicle to pedestrian (V2P) communication and the like in vehicle to everything (V2X) communication.

In some embodiments, the above wireless communication system may further include a network management device 13.

The several base station 12 are respectively connected to the network management device 13. The network management device 13 may be a core network device in the wireless communication system. For example, the network management device 13 may be a mobility management entity (MME) in an evolved packet core network (EPC). Alternatively, the network management device may be another core network device, such as a serving gateway (SGW), a public data network gateway (PGW), a policy and charging rule function (PCRF) or a home subscriber server (HSS). The implementation form of the network management device 13 is not limited in embodiments of the disclosure.

An execution body involved in the embodiments of the present disclosure includes, but is not limited to, a UE, such as a mobile phone supporting the cellular mobile communication, a base station, and the like.

An application scenario of the embodiments of the present disclosure is that the NR system can introduce a multi-carrier serving cell. As shown in FIG. 2, the multi-carrier serving cell is composed of multiple carriers, for example, CC1, CC2 and CC3, in which CC1 is a primary carrier, and CC2 and CC3 are secondary carriers. The UE can obtain system messages and receive paging only through the primary carrier CC1, and can perform radio resource management (RRM) and initiate physical random access channel (PRACH) access on all carriers. When the serving cell is an FR2 (i.e., Frequency Range 2) cell, the UE in an RRC idle state needs to reside in the FR2 cell according to an existing solution, which consumes more power. If a multi-carrier serving cell (one FR1 carrier and two FR2 carriers) is configured, the UE in the idle state can reside on the FR1 carrier, if there is a service, the UE initiates the PRACH, and directly returns to the FR2 carrier for data transmission and reception. In this way, the power saving effect of the base station can be achieved. Therefore, it is necessary to study a cell reselection configuration method for the UE in a multi-carrier serving cell scenario.

In the related art, the serving cell only includes one carrier, and the UE can determine whether to perform the cell reselection only according to a comparison result of a radio signal measurement value of the carrier and a reselection threshold for the carrier. A multi-carrier cell includes multiple carriers, and how the UE determines whether to perform the cell reselection in the multi-carrier cell is an urgent problem to be solved.

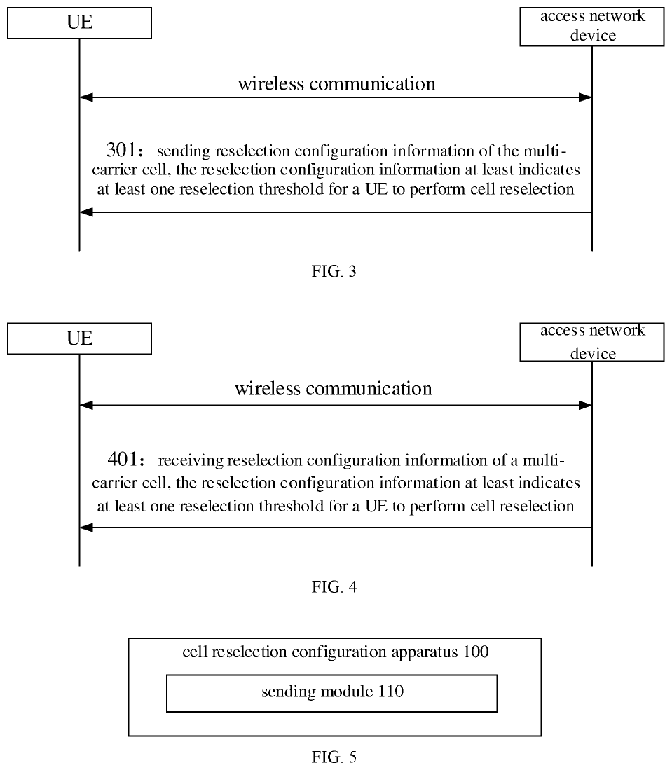

As shown in FIG. 3, the embodiment provides a cell reselection configuration method. The method can be applied to an access network device in a multi-carrier cell, and the method includes the following steps.

Step 301, reselection configuration information of the multi-carrier cell is sent. The reselection configuration information at least indicates at least one reselection threshold for a UE to perform cell reselection.

Here, the UE may be a mobile phone UE or the like that uses a cellular mobile communication technology to perform wireless communication. The multi-carrier cell may be the UE's current serving cell. The multi-carrier cell may include multiple carriers, including a primary carrier and a secondary carrier. The UE can obtain system messages and receive paging only through the primary carrier, and the UE can perform RRM measurement and initiate PRACH access on all carriers. The access network device may be a base station or the like that provides an access network interface to the UE in a cellular mobile communication system.

The access network device may send the reselection configuration information to indicate at least one reselection threshold to the UE. The reselection threshold may be a reselection threshold for one carrier, may be a reselection threshold for multiple carriers, or may be reselection thresholds for respective carriers. The UE may be a UE in an RRC idle state or a UE in an RRC inactive state, or may be a UE in a connected state.

The reselection threshold may be a threshold indicating a signal quality of a carrier. When a radio signal measurement value of the carrier is smaller than the reselection threshold, it may indicate that the signal quality of the carrier cannot meet the current communication requirement. The reselection threshold may include a signal strength threshold, a signal-to-noise ratio threshold, etc. The corresponding radio signal measurement value may include a signal strength value, a signal-to-noise ratio value, and the like.

The UE may determine the cell reselection based on the carrier for which the reselection threshold is received. For example, when only one carrier's reselection threshold is received, if the radio signal measurement value of the carrier is less than the reselection threshold, the cell reselection is performed: otherwise, the cell reselection is not performed and the UE continues to reside in the current serving cell.

In an embodiment, the access network device may carry the reselection configuration information in a system message and send it to the UE. For example, the access network device may carry the reselection configuration information in a system information block (SIB) and send it to the UE.

The UE may determine the carrier for which the radio signal measurement value needs to be compared with the reselection threshold, and perform radio signal measurement.

In an embodiment, the reselection threshold includes a reference signal receiving power (RSRP) threshold and/or a reference signal receiving quality (RSRQ) threshold.

The radio signal measurement value obtained by performing the radio signal measurement by the UE may include: RSRP and/or RSRQ. RSRP may be compared with the RSRP threshold, and/or RSRQ may be compared with the RSRQ threshold.

In this way, for the multi-carrier cell, the access network device may send the reselection configuration information indicating at least one reselection threshold, and the UE may determine the cell reselection based on the determined at least one reselection threshold. The access network device can flexibly indicate a determination condition for the cell reselection to the UE by sending different reselection thresholds, thus improving flexibility of the cell reselection, further realizing the cell reselection of the multi-carrier cell and meeting a requirement of cellular mobile communication.

In an embodiment, indication content of the reselection configuration information includes at least one of the following:
multiple reselection thresholds, in which different reselection thresholds are reselection thresholds for different carriers in the multi-carrier cell: or
one reselection threshold, in which the one reselection threshold is a reselection threshold collectively corresponding to different carriers in the multi-carrier cell.

The multi-carrier cell may include one primary carrier and at least one secondary carrier. Here, the multiple reselection thresholds indicated by the reselection configuration information may include reselection thresholds respectively corresponding to a radio signal measurement value of the primary carrier and at least one radio signal measurement value of the at least one secondary carrier. For example, the multiple reselection thresholds indicated by the reselection configuration information may include reselection thresholds respectively corresponding to all carriers in the multi-carrier cell. The multiple reselection thresholds indicated by the reselection configuration information may include reselection thresholds respectively corresponding to radio signal measurement values of multiple predetermined carriers, etc., for example, reselection thresholds respectively corresponding to all secondary carriers.

For example, the multiple reselection thresholds indicated by the reselection configuration information may include reselection thresholds respectively corresponding to the radio signal measurement value of the primary carrier and at least one radio signal measurement value of the at least one secondary carrier. For example, the reselection configuration information indicates multiple reselection thresholds R0, R1, . . . . Ri, where R0 is the reselection threshold corresponding to the primary carrier f0, i.e., the anchor frequency carrier, and R1 is the reselection threshold corresponding to the secondary carrier f1, i.e., the non-anchor frequency carrier, and Ri is the reselection threshold corresponding to the secondary carrier fi. Here, the reselection threshold can be the RSRP threshold or the RSRQ threshold etc.

The UE may select one or more reselection thresholds from the reselection thresholds respectively corresponding to different carriers in the multi-carrier cell and compare the one or more reselection thresholds with the radio signal measurement values of the respective carriers to determine whether to perform the cell reselection.

In an embodiment, the UE performs the cell reselection, in response to the reselection configuration information indicating multiple reselection thresholds, and the radio signal measurement values of the respective carriers being smaller than the reselection thresholds for the respective carriers.

For example, the multiple reselection thresholds indicated by the reselection configuration information may include reselection thresholds respectively corresponding to all carriers in the multi-carrier cell. The UE can perform the radio signal measurement on each carrier in the multi-carrier cell, and compare the radio signal measurement value of each carrier with the corresponding reselection threshold. If the radio signal measurement value of each carrier is smaller than the corresponding reselection threshold, it indicates that each carrier cannot meet the communication requirement, and the cell reselection is required.

For example, if the radio signal measurement values (RSRP or RSRQ) of the UE on all carriers are lower than the corresponding configured thresholds R0, R1, . . . . Ri, the UE may perform the cell reselection.

In this way, the UE compares the radio signal measurement values of different carriers with the corresponding reselection thresholds to determine whether to perform the cell reselection, which realizes evaluation of multiple carriers in the multi-carrier cell, and improves reliability of the cell reselection in the multi-carrier cell.

In an embodiment, the UE resides in the current serving cell and does not perform the cell reselection, in response to the reselection configuration information indicating multiple reselection thresholds, and the radio signal measurement value of at least one carrier being greater than or equal to the corresponding reselection threshold.

If the radio signal measurement value of at least one carrier is greater than or equal to the corresponding reselection threshold, it indicates that there is still a carrier in the current serving cell that can meet the communication requirement, and the UE can reside in the current serving cell.

In an embodiment, the reselection thresholds of different carriers in the multi-carrier cell at least include the reselection threshold for the primary carrier in the multi-carrier cell.

For example, the UE may only perform the radio signal measurement on the primary carrier in the multi-carrier cell, and compare the radio signal measurement value of the primary carrier with the reselection threshold for the primary carrier, if the radio signal measurement value of the primary carrier is less than the corresponding reselection threshold, it can be determined that the primary carrier cannot meet the communication requirement such as obtaining system messages and receiving paging, and that the cell reselection is required.

If the radio signal measurement value of the primary carrier is greater than or equal to the corresponding reselection threshold, it can be determined that the primary carrier can meet the communication requirement such as obtaining system messages and receiving paging, and that the UE can reside in the current serving cell.

Since the primary carrier carries system messages, paging messages, etc., the primary carrier plays a decisive role in communication. If the primary carrier does not meet the communication requirement, the UE and the base station cannot implement a complete communication process. Whether to perform the cell reselection is determined through the primary carrier, and since the UE only compares the radio signal measurement value of one carrier with the corresponding reselection threshold, an efficiency of cell reselection evaluation is improved.

The one reselection threshold indicated by the reselection configuration information may include a reselection threshold collectively corresponding to respective carriers in the carrier cell. The UE can compare the radio signal measurement values of respective carriers with the reselection threshold, or can compare a statistical value of the radio signal measurement values of respective carriers, such as a weighted average value, with the reselection threshold.

In an embodiment, the reselection threshold collectively corresponding to different carriers in the multi-carrier cell include a reselection threshold corresponding to an average value of radio signal measurement values of the different carriers.

For example, the UE may only perform the radio signal measurement on each carrier in the multi-carrier cell, and determine the average value of the radio signal measurement values of respective carriers, and then compare the average value with the reselection threshold corresponding to the average value. If the average value is smaller than the corresponding reselection threshold, it can be determined that the signal quality of the current serving cell is not good, and the cell reselection can be performed.

If the average value is greater than or equal to the corresponding reselection threshold, it can be determined that the signal quality of the current serving cell can meet the communication requirement, and the cell reselection may not be performed, and the UE may reside in the current serving cell.

By comparing the average value of the radio signal measurement values of the respective carriers with the corresponding reselection threshold to determine whether to perform the cell reselection, the number of compared reselection thresholds is reduced and the efficiency of cell reselection evaluation is improved.

As shown in FIG. 4, the embodiment provides an information transmission method. The method can be applied to a UE, and the method includes the following steps.

Step 401, reselection configuration information of a multi-carrier cell is received. The reselection configuration information at least indicates at least one reselection threshold for the UE to perform cell reselection.

Here, the UE may be a mobile phone UE or the like that uses a cellular mobile communication technology to perform wireless communication. The multi-carrier cell may be the UE's current serving cell. The multi-carrier cell may include multiple carriers, including a primary carrier and a secondary carrier. The UE can obtain system messages and receive paging only through the primary carrier, and the UE can perform RRM measurement and initiate PRACH access on all carriers. The access network device may be a base station or the like that provides an access network interface to the UE in a cellular mobile communication system.

The access network device may send the reselection configuration information to indicate at least one reselection threshold to the UE. The reselection threshold may be a reselection threshold for one carrier, may be a reselection threshold for multiple carriers, or may be reselection thresholds for respective carriers. The UE may be a UE in an RRC idle state or a UE in an RRC inactive state, or may be a UE in a connected state.

The reselection threshold may be a threshold indicating a signal quality of a carrier. When a radio signal measurement value of the carrier is smaller than the reselection threshold, it may indicate that the signal quality of the carrier cannot meet the current communication requirement. The reselection threshold may include a signal strength threshold, a signal-to-noise ratio threshold, etc. The corresponding radio signal measurement value may include a signal strength value, a signal-to-noise ratio value, and the like.

The UE may determine the cell reselection based on the carrier for which the reselection threshold is received. For example, when only one carrier's reselection threshold is received, if the radio signal measurement value of the carrier is less than the reselection threshold, the cell reselection is performed: otherwise, the cell reselection is not performed and the UE continues to reside in the current serving cell.

In an embodiment, the access network device may carry the reselection configuration information in a system message and send it to the UE. For example, the access network device may carry the reselection configuration information in a system information block (SIB) and send it to the UE.

The UE may determine the carrier for which the radio signal measurement value needs to be compared with the reselection threshold, and perform radio signal measurement.

In an embodiment, the reselection threshold includes a reference signal receiving power (RSRP) threshold and/or a reference signal receiving quality (RSRQ) threshold.

The radio signal measurement value obtained by performing the radio signal measurement by the UE may include: RSRP and/or RSRQ. RSRP may be compared with the RSRP threshold, and/or RSRQ may be compared with the RSRQ threshold.

In this way, for the multi-carrier cell, the access network device may send the reselection configuration information indicating at least one reselection threshold, and the UE may determine the cell reselection based on the determined at least one reselection threshold. The access network device can flexibly indicate a determination condition for the cell reselection to the UE by sending different reselection thresholds, thus improving flexibility of the cell reselection, further realizing the cell reselection of the multi-carrier cell and meeting a requirement of cellular mobile communication.

In an embodiment, indication content of the reselection configuration information includes at least one of the following:
multiple reselection thresholds, in which different reselection thresholds are reselection thresholds for different carriers in the multi-carrier cell: or
one reselection threshold, in which the one reselection threshold is a reselection threshold collectively corresponding to different carriers in the multi-carrier cell.

The multi-carrier cell may include one primary carrier and at least one secondary carrier. Here, the multiple reselection thresholds indicated by the reselection configuration information may include reselection thresholds respectively corresponding to a radio signal measurement value of the primary carrier and at least one radio signal measurement value of the at least one secondary carrier. For example, the multiple reselection thresholds indicated by the reselection configuration information may include reselection thresholds respectively corresponding to all carriers in the multi-carrier cell. The multiple reselection thresholds indicated by the reselection configuration information may include reselection thresholds respectively corresponding to radio signal measurement values of multiple predetermined carriers, etc., for example, reselection thresholds respectively corresponding to all secondary carriers.

For example, the multiple reselection thresholds indicated by the reselection configuration information may include reselection thresholds respectively corresponding to the radio signal measurement value of the primary carrier and at least one radio signal measurement value of the at least one secondary carrier. For example, the reselection configuration information indicates multiple reselection thresholds R0, R1, . . . . Ri, where R0 is the reselection threshold corresponding to the primary carrier f0 (i.e., the anchor frequency carrier), and R1 is the reselection threshold corresponding to the secondary carrier f1 (i.e., the non-anchor frequency carrier), and Ri is the reselection threshold corresponding to the secondary carrier fi. Here, the reselection threshold can be the RSRP threshold or the RSRQ threshold etc.

In an embodiment, the method further includes: performing the cell reselection based on a comparison result of the radio signal measurement value of the multi-carrier cell and the reselection threshold.

The UE may select one or more reselection thresholds from the reselection thresholds respectively corresponding to different carriers in the multi-carrier cell and compare the one or more reselection thresholds with the radio signal measurement values of the respective carriers to determine whether to perform the cell reselection.

In an embodiment, performing the cell reselection based on the comparison result of the radio signal measurement value of the multi-carrier cell and the reselection threshold includes:
in response to the reselection configuration information indicating multiple reselection thresholds, and the radio signal measurement values of respective carriers being smaller than the reselection thresholds for the respective carriers, performing the cell reselection.

For example, the multiple reselection thresholds indicated by the reselection configuration information may include reselection thresholds respectively corresponding to all carriers in the multi-carrier cell. The UE can perform the radio signal measurement on each carrier in the multi-carrier cell, and compare the radio signal measurement value of each carrier with the corresponding reselection threshold. If the radio signal measurement value of each carrier is smaller than the corresponding reselection threshold, it indicates that each carrier cannot meet the communication requirement, and the cell reselection is required.

For example, if the radio signal measurement values (RSRP or RSRQ) of the UE on all carriers are lower than the corresponding configured thresholds R0, R1, . . . . Ri, the UE may perform the cell reselection.

In this way, the UE compares the radio signal measurement values of different carriers with the corresponding reselection thresholds to determine whether to perform the cell reselection, which realizes evaluation of multiple carriers in the multi-carrier cell, and improves reliability of the cell reselection in the multi-carrier cell.

In an embodiment, the UE resides in the current serving cell and does not perform the cell reselection, in response to the reselection configuration information indicating multiple reselection thresholds, and the radio signal measurement value of at least one carrier being greater than or equal to the corresponding reselection threshold.

If the radio signal measurement value of at least one carrier is greater than or equal to the corresponding reselection threshold, it indicates that there is still a carrier in the current serving cell that can meet the communication requirement, and the UE can reside in the current serving cell.

In an embodiment, the reselection thresholds of different carriers in the multi-carrier cell at least include the reselection threshold for the primary carrier in the multi-carrier cell.

In an embodiment, performing the cell reselection based on the comparison result of the radio signal measurement value of the multi-carrier cell and the reselection threshold includes:

in response to the multiple reselection thresholds indicated by the reselection configuration information including the reselection threshold for the primary carrier, and the radio signal measurement value of the primary carrier being smaller than the reselection threshold for the primary carrier, performing the cell reselection.

For example, the UE may only perform the radio signal measurement on the primary carrier in the multi-carrier cell, and compare the radio signal measurement value of the primary carrier with the reselection threshold for the primary carrier, if the radio signal measurement value of the primary carrier is smaller than the corresponding reselection threshold, it can be determined that the primary carrier cannot meet the communication requirement such as obtaining system messages and receiving paging, and that the cell reselection is required.

If the radio signal measurement value of the primary carrier is greater than or equal to the corresponding reselection threshold, it can be determined that the primary carrier can meet the communication requirement such as obtaining system messages and receiving paging, and that the UE can reside in the current serving cell.

Since the primary carrier carries system messages, paging messages, etc., the primary carrier plays a decisive role in communication. If the primary carrier does not meet the communication requirement, the UE and the base station cannot implement a complete communication process. Whether to perform the cell reselection is determined through the primary carrier, and since the UE only compares the radio signal measurement value of one carrier with the corresponding reselection threshold, an efficiency of cell reselection evaluation is improved.

The one reselection threshold indicated by the reselection configuration information may include a reselection threshold collectively corresponding to respective carriers in the carrier cell. The UE can compare the radio signal measurement values of respective carriers with the reselection threshold, or can compare a statistical value of the radio signal measurement values of respective carriers, such as a weighted average value, with the reselection threshold, and determines whether to perform the cell reselection based on the comparison result.

In an embodiment, the reselection threshold collectively corresponding to different carriers in the multi-carrier cell include a reselection threshold corresponding to an average value of radio signal measurement values of the different carriers.

In an embodiment, performing the cell reselection based on the comparison result of the radio signal measurement value of the multi-carrier cell and the reselection threshold includes:

in response to the reselection configuration information indicating the reselection threshold corresponding to the average value of the radio signal measurement values of the different carriers, and the average value of the radio signal measurement values of the different carriers being less than the reselection threshold, performing the cell reselection.

For example, the UE may only perform the radio signal measurement on respective carriers in the multi-carrier cell, and determine the average value of the radio signal measurement values of the respective carriers, and then compare the average value with the reselection threshold corresponding to the average value. If the average value is smaller than the corresponding reselection threshold, it can be determined that the signal quality of the current serving cell is not good, and the cell reselection can be performed.

If the average value is greater than or equal to the corresponding reselection threshold, it can be determined that the signal quality of the current serving cell can meet the communication requirement, and the cell reselection may not be performed, and the UE may reside in the current serving cell.

By comparing the average value of the radio signal measurement values of the respective carriers with the corresponding reselection threshold to determine whether to perform the cell reselection, the number of compared reselection thresholds is reduced and the efficiency of cell reselection evaluation is improved.

A specific example is provided below in combination with any of the above-mentioned embodiments.

1. The serving cell configures the cell reselection threshold through the SIB system message. There are the following ways to configure the cell reselection threshold.

Configuration way 1: configure multiple cell reselection thresholds R0, R1, . . . . Ri, where R0 is the reselection threshold corresponding to the primary carrier f0 (i.e., the anchor frequency carrier), and R1 is the reselection threshold corresponding to the secondary carrier f1 (i.e., the non-anchor frequency carrier), and Ri is the reselection threshold corresponding to the secondary carrier fi.

Configuration mode 2: configure one cell reselection threshold R.

2. The UE evaluates whether to perform a cell reselection procedure by the following methods.

Method 1: the measurement value (RSRP or RSRQ) of the UE on the primary carrier is lower than the configured reselection threshold R0.

Method 2: the measurement values (RSRP or RSRQ) of the UE on all carriers are lower than the corresponding configured reselection thresholds R0, R1, . . . . Ri.

Method 3: the average value of measurement values of the UE on all carriers is lower than the configured threshold R.

3. If any of the conditions desired in “2” is met, the UE initiates the cell reselection procedure.

Embodiments of the present invention also provide a cell reselection configuration apparatus, which is applied to an access network device of a multi-carrier cell. As shown in FIG. 5, the cell reselection configuration apparatus 100 includes: a sending module 110.

The sending module 110 is configured to send reselection configuration information of the multi-carrier cell, in which the reselection configuration information at least indicates at least one reselection threshold for a user equipment (UE) to perform cell reselection.

In an embodiment, indication content of the reselection configuration information includes at least one of:
a plurality of reselection thresholds, in which different reselection thresholds are reselection thresholds for different carriers in the multi-carrier cell: or
one reselection threshold, in which the one reselection threshold is a reselection threshold collectively corresponding to different carriers in the multi-carrier cell.

In an embodiment, the reselection thresholds for different carriers in the multi-carrier cell at least include a reselection threshold for a primary carrier in the multi-carrier cell.

In an embodiment, the reselection threshold collectively corresponding to different carriers in the multi-carrier cell includes a reselection threshold corresponding to an average value of radio signal measurement values of the different carriers.

In an embodiment, the reselection threshold includes a reference signal receiving power (RSRP) threshold and/or a reference signal receiving quality (RSRQ) threshold.

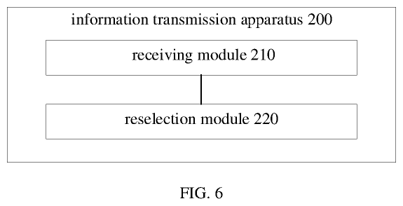

Embodiments of the present invention also provide an information transmission apparatus, which is applied to a UE. As shown in FIG. 6, the information transmission apparatus 200 includes a receiving module 210.

The receiving module 210 is configured to receive reselection configuration information of a multi-carrier cell, in which the reselection configuration information at least indicates at least one reselection threshold for the UE to perform cell reselection.

In an embodiment, indication content of the reselection configuration information includes at least one of:
a plurality of reselection thresholds, in which different reselection thresholds are reselection thresholds for different carriers in the multi-carrier cell: or
one reselection threshold, in which the one reselection threshold is a reselection threshold collectively corresponding to different carriers in the multi-carrier cell.

In an embodiment, the reselection thresholds for different carriers in the multi-carrier cell at least include a reselection threshold for a primary carrier in the multi-carrier cell.

In an embodiment, the reselection threshold collectively corresponding to different carriers in the multi-carrier cell includes a reselection threshold corresponding to an average value of radio signal measurement values of the different carriers.

In an embodiment, the apparatus also includes:

a reselection module 220 configured to perform the cell reselection based on a comparison result of a radio signal measurement value of the multi-carrier cell and the reselection threshold.

In one embodiment, the reselection module 220 is configured to, in response to the reselection configuration information indicating the plurality of reselection thresholds, and radio signal measurement values of carriers being smaller than the reselection thresholds for the carriers respectively, perform the cell reselection.

In an embodiment, the reselection module 220 is configured to, in response to the plurality of reselection thresholds indicated by the reselection configuration information including the reselection threshold for the primary carrier, and a radio signal measurement value of the primary carrier being smaller than the reselection threshold for the primary carrier, perform the cell reselection.

In an embodiment, the reselection module 220 is configured to, in response to the reselection configuration information indicating the reselection threshold corresponding to the average value of the radio signal measurement values of the different carriers, and the average value being less than the reselection threshold, perform the cell reselection.

In an embodiment, the reselection threshold includes a reference signal receiving power (RSRP) threshold and/or a reference signal receiving quality (RSRQ) threshold.

In an embodiment, the sending module 110, the receiving module 210 and the reselecting module 220 may be implemented by one or more central processing units (CPUs), graphics processing units (GPUs), baseband processors (BPs), application specific integrated circuits (ASICs), DSPs, programmable logic devices (PLDs), complex programmable logic devices (CPLDs), field programmable gate array (FPGAs), general-purpose processors, controllers, micro controller units (MCUs), microprocessors, or other electronic components, to perform the aforementioned methods.

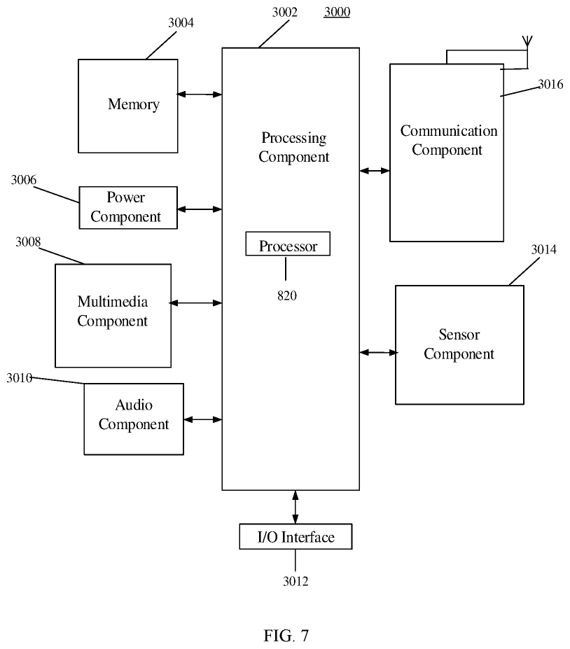

FIG. 7 is a block diagram illustrating an apparatus 3000 for cell reselection configuration or information transmission according to an embodiment. For example, the apparatus 3000 may be a mobile phone, a computer, a digital broadcast user device, a messaging sending and receiving equipment, a game console, a tablet, a medical device, a fitness device, a personal digital assistant, or the like.

As illustrated in FIG. 7, the apparatus 3000 may include one or more of: a processing component 3002, a memory 3004, a power component 3006, a multimedia component 3008, an audio component 3010, an input/output (I/O) interface 3012, a sensor component 3014, and a communication component 3016.

The processing component 3002 typically controls overall operations of the apparatus 3000, such as the operations associated with display, telephone calls, data communications, camera operations, and recording operations. The processing component 3002 may include one or more processors 3020 to execute instructions to perform all or part of the steps in the above-described methods. Moreover, the processing component 3002 may include one or more modules which facilitate the interaction between the processing component 3002 and other components. For example, the processing component 3002 may include a multimedia module to facilitate the interaction between the multimedia component 3008 and the processing component 3002.

The memory 3004 is configured to store various types of data to support the operation of the apparatus 3000. Examples of such data include instructions for any applications or methods operated on the apparatus 3000 for performing contraction data, phonebook data, messages, pictures, video, etc. The memory 3004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 3006 is configured to provide power to various components of the apparatus 3000. The power component 3006 may include a power management system, one or more power sources, and any other components associated with the generation, management, and distribution of power in the apparatus 3000.

The multimedia component 3008 includes a screen providing an output interface between the apparatus 3000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 3008 includes a front camera and/or a rear camera. The front camera and the rear camera may receive an external multimedia datum while the apparatus 3000 is in an operation mode, such as a photographing mode or a video mode. Each of the front camera and the rear camera may be a fixed optical lens system or have focus and optical zoom capability.

The audio component 3010 is configured to output and/or input audio signals. For example, the audio component 3010 includes a microphone (“MIC”) for receiving an external audio signal when the apparatus 3000 is in an operation mode, such as a call mode, a recording mode, and a speech recognition mode. The received audio signal may be further stored in the memory 3004 or transmitted via the communication component 3016. In some embodiments, the audio component 3010 further includes a speaker to output audio signals.

The I/O interface 3012 is configured to provide an interface between the processing component 3002 and peripheral interface modules, such as a keyboard, a click wheel, buttons, and the like. The buttons may include, but be not limited to, a home button, a volume button, a starting button, and a locking button.

The sensor component 3014 includes one or more sensors for providing status assessments of various aspects of the apparatus 3000. For example, the sensor component 3014 may detect an open/closed status of the apparatus 3000, relative positioning of components, e.g., the display and the keypad of the apparatus 3000, a change in position of the apparatus 3000 or a component of the apparatus 3000, a presence or absence of user contraction with the apparatus 3000, an orientation or an acceleration/deceleration of the apparatus 3000, and a change in temperature of the apparatus 3000. The sensor component 3014 may include a proximity sensor for detecting the presence of nearby objects without any physical contact. The sensor component 3014 may also include a light sensor, such as a CMOS (complementary metal-oxide-semiconductor)) or a CCD (charge coupled device) image sensor, for use in imaging applications. In some embodiments, the sensor component 3014 may also include an accelerometer sensor, a gyroscope sensor, a magnetic sensor, a pressure sensor, or a temperature sensor.

The communication component 3016 is configured to facilitate communication, wired or wirelessly, between the apparatus 3000 and other devices. The apparatus 3000 may access a wireless network based on a communication standard, such as Wi-Fi, 2G, or 3G, or a combination thereof. In an exemplary embodiment, the communication component 3016 receives a broadcast signal or broadcast associated information from an external broadcast management system via a broadcast channel. In an exemplary embodiment, the communication component 3016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the apparatus 3000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing any of the above methods.

In an exemplary embodiment, there is also provided a non-transitory computer readable storage medium including instructions, such as the memory 3004 including the instructions. The instructions may be executed by the processor 3020 in the apparatus 3000 for performing any of the above methods. For example, the non-transitory computer readable storage medium may be a ROM, a RAM, a CD-ROM, a magnetic tape, a floppy disc, an optical data storage device, and the like.

Other implementations of the disclosure may be apparent to the skilled in the art from consideration of the specification and practice of the disclosure disclosed here. This disclosure is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims.

It should be understood that the disclosure is not limited to the exaction construction that has been described above and illustrated in the accompanying drawings, and that various modifications and changes may be made without departing from the scope thereof. The scope of the disclosure only is limited by the appended claims.

1. A cell reselection configuration method, performed by an access network device of a multi-carrier cell, comprising:
sending reselection configuration information of the multi-carrier cell, wherein the reselection configuration information at least indicates at least one reselection threshold for a user equipment (UE) to perform cell reselection.

2. The method of claim 1, wherein indication content of the reselection configuration information comprises at least one of:
a plurality of reselection thresholds, wherein different reselection thresholds are reselection thresholds for different carriers in the multi-carrier cell; or
one reselection threshold, wherein the one reselection threshold is a reselection threshold collectively corresponding to different carriers in the multi-carrier cell.

3. The method of claim 2, wherein the reselection thresholds for different carriers in the multi-carrier cell at least comprise a reselection threshold for a primary carrier in the multi-carrier cell.

4. The method of claim 2, wherein the reselection threshold collectively corresponding to different carriers in the multi-carrier cell comprises a reselection threshold corresponding to an average value of radio signal measurement values of the different carriers.

5. The method of claim 1, wherein the at least one reselection threshold comprises at least one of a reference signal receiving power (RSRP) threshold and/or or a reference signal receiving quality (RSRQ) threshold.

6. An information transmission method, performed by a user equipment (UE), comprising:
receiving reselection configuration information of a multi-carrier cell, wherein the reselection configuration information at least indicates at least one reselection threshold for the UE to perform cell reselection.

7. The method of claim 6, wherein indication content of the reselection configuration information comprises at least one of:
a plurality of reselection thresholds, wherein different reselection thresholds are reselection thresholds for different carriers in the multi-carrier cell; or
one reselection threshold, wherein the one reselection threshold is a reselection threshold collectively corresponding to different carriers in the multi-carrier cell.

8. The method of claim 7, wherein the reselection thresholds for different carriers in the multi-carrier cell at least comprise a reselection threshold for a primary carrier in the multi-carrier cell.

9. The method of claim 7, wherein the reselection threshold collectively corresponding to different carriers in the multi-carrier cell comprises a reselection threshold corresponding to an average value of radio signal measurement values of the different carriers.

10. The method of claim 7, further comprising:
performing the cell reselection based on a comparison result of a radio signal measurement value of the multi-carrier cell and the at least one reselection threshold.

11. The method of claim 10, wherein performing the cell reselection based on the comparison result of the radio signal measurement value of the multi-carrier cell and the at least one reselection threshold comprises:
performing the cell reselection, wherein in response to the reselection configuration information indicates the plurality of reselection thresholds, and radio signal measurement values of carriers are smaller than the reselection thresholds for the carriers respectively.

12. The method of claim 10, wherein performing the cell reselection based on the comparison result of the radio signal measurement value of the multi-carrier cell and the at least one reselection threshold comprises:
performing the cell reselection, wherein the plurality of reselection thresholds indicated by the reselection configuration information include a reselection threshold for a primary carrier, and a radio signal measurement value of the primary carrier is smaller than the reselection threshold for the primary carrier.

13. The method of claim 10, wherein performing the cell reselection based on the comparison result of the radio signal measurement value of the multi-carrier cell and the at least one reselection threshold comprises:
performing the cell reselection, wherein to the reselection configuration information indicates a reselection threshold corresponding to an average value of radio signal measurement values of the different carriers, and the average value is smaller than the reselection threshold.

14. The method of claim 6, wherein the at least one reselection threshold comprises at least one of a reference signal receiving power (RSRP) threshold or a reference signal receiving quality (RSRQ) threshold.

15.-18. (canceled)

19. An access network device, comprising:
a processor; and
a memory storing an executable program stored on the memory and executable by the processor,
wherein the processor is configured to:
send reselection configuration information of a multi-carrier cell, wherein the reselection configuration information at least indicates at least one reselection threshold for a user equipment (UE) to perform cell reselection.

20. A non-transitory storage medium, having an executable program stored thereon, wherein when the executable program is executed by a processor, the processor is caused to perform the method of claim 1.

21. The access network device of claim 19, wherein indication content of the reselection configuration information comprises at least one of:
a plurality of reselection thresholds, wherein different reselection thresholds are reselection thresholds for different carriers in the multi-carrier cell; or
one reselection threshold, wherein the one reselection threshold is a reselection threshold collectively corresponding to different carriers in the multi-carrier cell.

22. The access network device of claim 21, wherein the reselection thresholds for different carriers in the multi-carrier cell comprise a reselection threshold for a primary carrier in the multi-carrier cell.

23. The access network device of claim 21, wherein the at least one reselection threshold collectively corresponding to different carriers in the multi-carrier cell comprises a reselection threshold corresponding to an average value of radio signal measurement values of the different carriers.

24. A user equipment (UE), comprising:
a processor; and
a memory storing program executable by the processor;
wherein the processor is configured to perform the method of claim 6.
